(19) United States
(12) Patent Application Publication
(10) Pub. No.: US 2010/0294574 A1
(43) Pub. Date: Nov. 25, 2010

(54) LED stylus pen

(76) Inventor: Eric Chen, Taipei (TW)

Correspondence Address: PRO-TECHTOR INTERNATIONAL SERVICES, 20775 NORADA CT., SARATOGA, CA, 95070, US

(21) Appl. No.: 12/470,180

(22) Filed: May 21, 2009

(51) Int. Cl. G06F 3/033; G08C 21/00

(52) U.S. Cl. 178/19.05; 345/179

(57) ABSTRACT

The present invention discloses structure improvement of an LED stylus pen, wherein a button is defined at topmost of the stylus pen. When a user pushes down the button and touches a touch screen, a switch is actuated, providing power to an LED to emit light. When the button is pushed down again and the touch screen is touched, the LED will not emit light.

### BACKGROUND OF THE INVENTION

a) Field of the Invention

The present invention relates to an LED stylus pen, and more particularly to an LED stylus pen wherein a button is defined at topmost of the stylus pen and when the button is pushed down, a switch is actuated to provide power for the LED to emit light.

b) Description of the Prior Art

An ordinary conventional stylus pen is used for touching a touch screen, allowing an LED at a front end of the stylus pen to emit light. The LED light will be emitted as long as the stylus pen touches the touch screen; however, sometimes a user will not want that the light is emitted when touching the touch screen due to work, therefore, the conventional stylus pen cannot comply with the user's requirement.

### SUMMARY OF THE INVENTION

The primary object of the present invention to provide an LED stylus pen wherein a button is fitted on top of the stylus pen. When the button is pushed down that a conductive spring is pressed down to touch an anode of a battery, and if the LED touches a touch screen such that a conductor touches a cathode of the battery, then the LED can emit light; whereas, when the button is pushed down again that the button bounces back upward, allowing the conductive spring not touch the anode of the battery, and if the LED touches the touch screen, then the LED will not emit the light. Therefore, the pen of the present invention is provided with an effect to control the LED to emit light by touching.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of the present invention.

FIG. 2 shows an exploded view of the present invention.

FIG. 3 shows a cross-sectional view of the present invention.

FIG. 4 shows a cross-sectional view of the present invention, wherein a button is pushed down to turn on an LED switch.

FIG. 5 shows a cross-sectional view of the present invention, wherein a touch screen is touched to allow an LED to emit light.

FIG. 6 shows a cross-sectional view of an embodiment of the present invention.

### DETAILED DESCRIPTION OF THE PREFERRED EMBODIMENTS

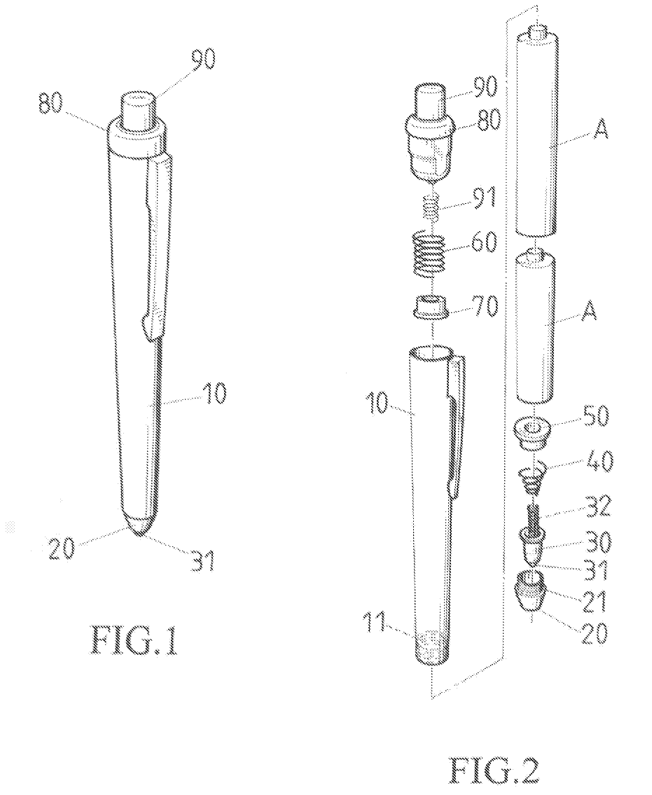

Referring to FIGS. 1 to 3, the present invention comprises a penholder 10, a pen nib 20, a lamp tube 30, a first spring 40, a first insulator 50, a second spring 60, a second insulator 60, a metal tube 80 and a button 90.

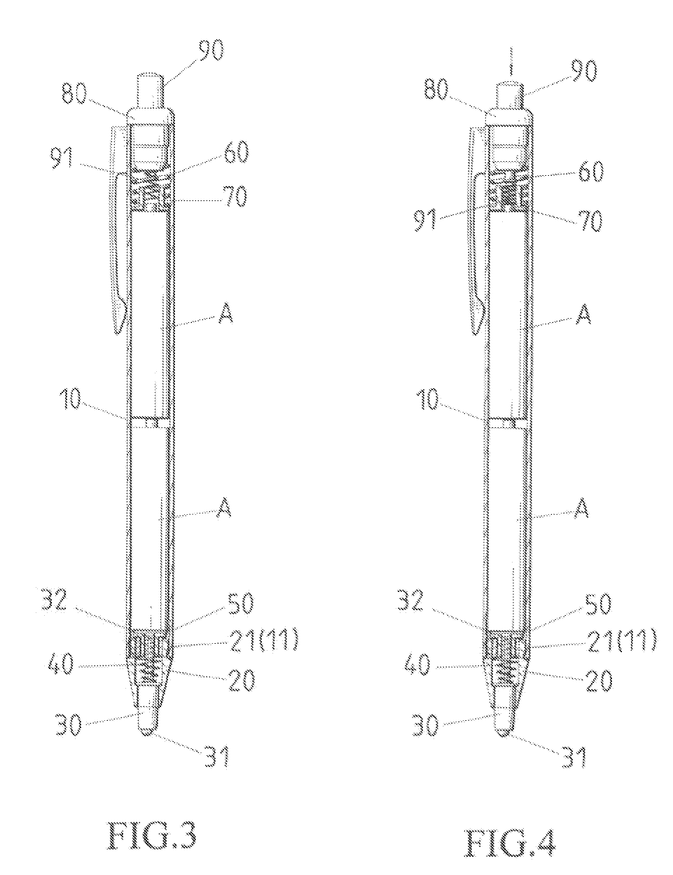

A lower side of the hollow penholder 10 is connected to the pen nib 20, an upper side is connected to the metal tube 80, and the hollow pen nib 20 is fixed by locking an outer thread 21 on a top end with an inner thread 11 at an inner rim of a bottom end of the penholder 10 (as shown in FIG. 3). An interior of the hollow lamp tube 30 is latched with an LED 31, an end of which is connected to a conductor 32. The helical-shape first spring 40 is sheathed at an exterior side of the conductor 32 and is locked into the lamp tube 30. The T-shape first insulator 50 is sheathed at a top end of the first spring 40 and is latched on an opening end at a top end of the pen nib 20. The aforementioned parts are assembled and extended into the penholder 10, and are located below two 1.5V batteries A which are serially connected in the penholder 10. The lower-side battery A is abutted above the first insulator 50, and the upper-side battery A is abutted below the second insulator 70 on which is sheathed with the second spring 60.

A tube opening above the penholder 10 is latched with the hollow metal tube 80 which is in contact with the second insulator 70. A button 90, which transfixes the metal tube 80 and a bottom end of which is sheathed with a conductive spring 91, with the conductive spring 91 transfixing the hollow second spring 60 and the second insulator 70. In a normal time when the button 90 is not pushed down, a conductive spring 91 does not touch the battery A. On the other hand, when the button 90 is pushed down, the conductive spring 91, will touch the battery A in the penholder 10. When a user presses the button 90 for a first time, the button 90 can be pushed down, and when the button 90 is pushed again, the restoring spring 91 can bounce back the button 90 to an original position.

Referring to FIG. 3, when the button 90 is not pushed down, the conductive spring 91 at a bottom end of the button 90 does not touch an anode of the battery A and is away from the battery A by a distance. When the user uses the LED 31 to touch a touch screen B (not shown in the drawing), the LED 31 does not emit light. Referring to FIG. 4, when the user pushes down the button 90, the conductive spring 91 is pressed down to touch the anode of the battery A. Referring to FIG. 5, as long as that the user uses the LED 31 to touch the touch screen B, the conductor 32 at one end of the LED 31 can touch a cathode of the battery A, allowing the LED 31 to emit light.

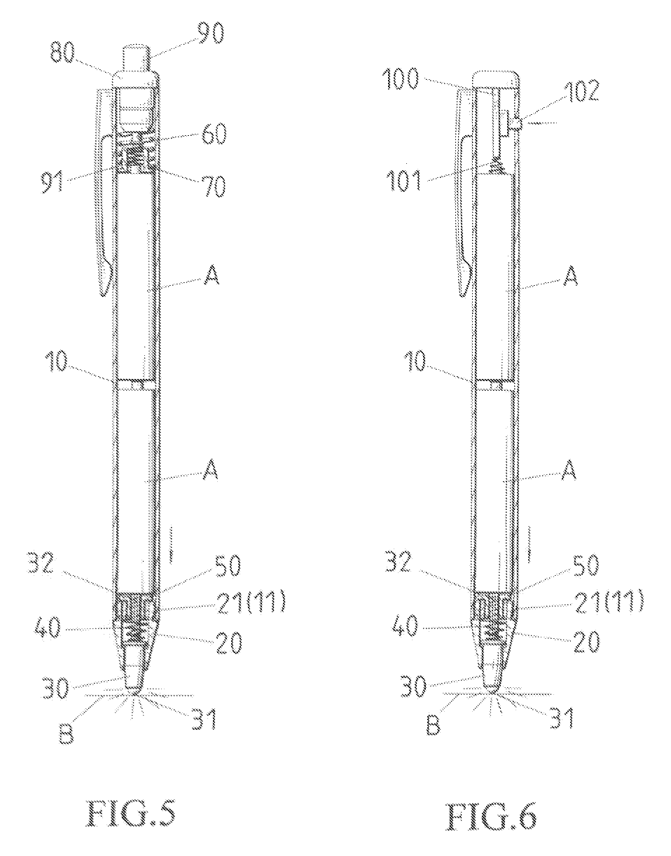

Referring to FIG. 6, it shows a cross-sectional view of an embodiment of the present invention, wherein a switch which controls the LED to emit light is changed from a button to a circuit board 100. A lower end of the circuit board 100 which is located in the penholder 10 is connected to a conductive spring 101 to touch the anode of the battery A. The circuit board 100 is provided with a push switch 102 which is extended out of the penholder 10. When the user pushes down the push switch 102 such that the circuit board 100 can conduct current with the batteries A, and when the LED 31 touches the touch screen B, the conductor 32 at one end of the LED 31 can touch the cathode of the battery A, allowing the LED 31 to emit light.

Conclusive from the above, in accordance with the present invention, a button is pushed down and a touch screen is touched that power can be provided to an LED to emit light. The button or a switch is defined at topmost of a stylus pen such that when a user pushes down the button and touches the touch screen, the switch will be actuated, so as to provide power to the LED to emit light.

What is claim is:

1. An LED stylus pen comprising a penholder, which is provided with two batteries and an end of which is provided with a threaded hole; a pen nib, which is a hollow structure and an outer thread of which is locked with an inner thread of the penholder; a lamp tube, which is a hollow structure and an interior of which is latched with an LED, an end of the LED being connected to a conductor; a first spring which is sheathed at an exterior side of the conductor of the lamp tube and is locked into the lamp tube; a first insulator which is sheathed at an end of the first spring and is latched at an opening end of the pen nib; a second spring which is located on a top end of the upper-side battery; a second insulator which is sheathed at a lower end of the second spring; a metal tube which is a hollow structure and is latched at a bottom end of a tube opening above the penholder, and is abutted on the second spring; and a button, which transfixes the metal tube and a bottom end of which is sheathed with a conductive spring, with the conductive spring transfixing the second spring and the second insulator to touch the upper-side battery; a user pushing down the button to press down the conductive spring to touch the upper-side battery and when the user using the LED to touch a touch screen, the conductor touching the lower-side battery to allow the LED to emit light.

2. The LED stylus pen according to claim 1, wherein a circuit board is fitted on the pen holder, a lower end of the circuit board is connected to a conductive spring to touch the upper-side battery, and the circuit board is further provided with a push switch which is extended out of the penholder; when the user pushing down the push switch and then using the LED to touch the touch screen, the LED emitting light.
